(19) United States
(12) Patent Application Publication
(10) Pub. No.: US 2018/0089450 A1
(43) Pub. Date: Mar. 29, 2018

(54) TAXONOMY-FACILITATED ACTIONS FOR CONTENT

(71) Applicant: PROLIFIQ SOFTWARE INC., Beaverton, OR (US)

(72) Inventors: Anh Huynh, Tigard, OR (US); Hemingway Huynh, Salem, OR (US); Jeffrey Michael Farnsworth, Portland, OR (US); Isabella Wong, Bellevue, WA (US)

(21) Appl. No.: 15/201,085

(22) PCT Filed: Feb. 2, 2016
(86) PCT No.: PCT/US2016/016227

§ 371 Date: Jul. 1, 2016

Related U.S. Application Data
(60) Provisional application No. 62/111,029, filed on Feb. 2, 2015.

(51) Int. Cl. G06F 21/62

(52) U.S. Cl. CPC G06F 21/6209; G06F 17/2775

(57) ABSTRACT

Embodiments relating to a regulated taxonomy system (“RTS”) are described. A user, when performing a communication with another party, may be provided with pieces of regulated taxonomy. Association of a piece of regulated taxonomy may facilitate actions to be performed with reference to the communication or piece of content. The RTS may interact with one or more devices to present pieces of taxonomy to a user and to receive a selection of taxonomy. The device may perform or modify actions which may be taken with relation to the piece of content or communication. The RTS may also generate pieces of taxonomy by reviewing content. The RTS may provide for one or more approvers to review taxonomy and/or generate new taxonomy. The RTS may also be configured to modify regulated taxonomy according to actions which have been performed. Other embodiments may be described and/or claimed.

### CROSS-REFERENCE TO RELATED APPLICATION

This application claims the benefit of U.S. Provisional Application No. 62/111,029, filed Feb. 2, 2015, and entitled “METHODS, SYSTEMS, AND APPARATUSES FOR REGULATED TAXONOMY AND SEARCHING”, which is incorporated herein by reference in its entirety.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Representatives in certain industries (such as pharmaceutical and medical device manufacturing), frequently interface with providers of services (such as health care providers) in order to educate and answer questions about the products or services they represent. However, at times, these representatives may seek to provide or generate information relating to communications with the providers. For example, a representative may desire to send a brochure for a drug or a device with a provider. In another example, the representative may set up a phone call or video conference with a provider and may wish to record that communication.

However, in many such situations, the representative, the provider, or a system used by the representative provider may wish to control actions that may be performed with respect to the content or the communication. For example, the system may wish to control how and when the content is shared, or particular modifications that may be made to the content. However, it can be difficult to view and set up such modifications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figs. of the accompanying drawings.

FIG. 1 illustrates an arrangement for a regulated taxonomy system, in accordance with various embodiments.

FIG. 2 illustrates an example process for facilitating communication using regulated taxonomy, in accordance with various embodiments.

FIG. 3 illustrates an example process for setting up an initial set of regulated taxonomy, in accordance with various embodiments.

FIG. 4 illustrates an example process for performing modifications of actions or content based on selected taxonomy, in accordance with various embodiments.

FIG. 5 illustrates an example process for modifying taxonomy, in accordance with various embodiments.

FIG. 6 illustrates an example interface provided by one or more modules of a representative device, in accordance with various embodiments.

FIG. 7 illustrates an example computing environment suitable for practicing various aspects of the present disclosure in accordance with various embodiments.

FIG. 8 illustrates an example storage medium with instructions configured to enable an apparatus to practice various aspects of the present disclosure in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

Embodiments described herein are directed to, for example, methods, apparatuses, systems, and computer-readable media for a regulated taxonomy system (“RTS”) to facilitate actions relating to content and communications. In various embodiments, a user, such as a representative, when performing a communication with another party, such as a provider, may be provided with one or more pieces of regulated taxonomy which may be associated with the communication. In various embodiments, the communication may be performed with respect to a piece of content, such as a document, presentation, movie, audio file, etc. In various embodiments, the association of a piece of regulated taxonomy with a communication and/or a piece of content may facilitate one or more actions which may be performed with reference to the communication or piece of content. For example, a piece of content relating to a drug may be associated with a piece of regulated taxonomy associated with a malady treated by the drug. Through selection of the piece of taxonomy with the piece of content, a device of a representative may be provided with one or more actions that may now be performed with the piece of content. In one example, the device of the representative may be permitted to share the content with specific providers and/or provider groups after association with a piece of taxonomy. In another example, a piece of taxonomy that is associated with a regulated drug or device may cause modification of a piece of content to facilitate compliance with regulations. For example, the RTS, or a mobile device which may communicate with the RTS, may add regulatory information to a piece of content and/or may redact or delete information as needed by regulations.

In various embodiments, the RTS may interact with one or more devices which may be configured to perform various regulated taxonomy techniques as described herein. For example, a computing device of a representative (such as a mobile device, laptop computer, etc.) may be configured to receive one or more indications of pieces of taxonomy from the RTS to be associated with a communication or piece of content. The computing devices may be configured to present these pieces of taxonomy to a user, such as a representative, and to receive a selection of one or more pieces of taxonomy to associate with a piece of content or communication. The computing device may then be configured to perform or modify actions which may be taken with relation to the piece of content or communication based on the selection of the one or more pieces of taxonomy. In various embodiments, the RTS may also be configured to generate one or more pieces of taxonomy, such as by reviewing content from content sources and determining pieces of taxonomy that may be related to the pieces of content. In various embodiments, the RTS may be configured to provide for regulation of the taxonomy, such as by providing for one or more approvers to review taxonomy and/or generate new taxonomy. In various embodiments, the RTS may also be configured to modify regulated taxonomy according to actions which have been performed in association with one or more pieces of taxonomy. For example, as pieces of content are shared with particular recipients or modified, the RTS may receive this information and may modify regulated taxonomy accordingly. In various embodiments, the RTS may utilize machine learning in order to modify, create, predict, and/or align existing or new regulated taxonomy.

It may be noted that particular examples are provided, for the sake of example, with reference to particular roles or professions. For example, embodiments are described herein with reference to “providers”, “representatives”, “physicians”, etc. It maybe noted, however, that various embodiments may be practiced to facilitate communication between various persons and/or roles, and that the embodiments and techniques described herein should not be read to be limited by any particular roles used for exemplary description. Further, it may be noted that, while “content” and “pieces of content” are referred to herein, no particular limitation is implied on the types or formats of content that may be utilized. Thus, in various embodiments, “content” may include, textual content, image content, audio content, video content, slides, presentations, etc. Further, content may, in various embodiments, be received from external sources and/or internally. For example, a communication between a representative and a provider, such as, for example, an audio or video communication, may be recorded to generate a piece of content.

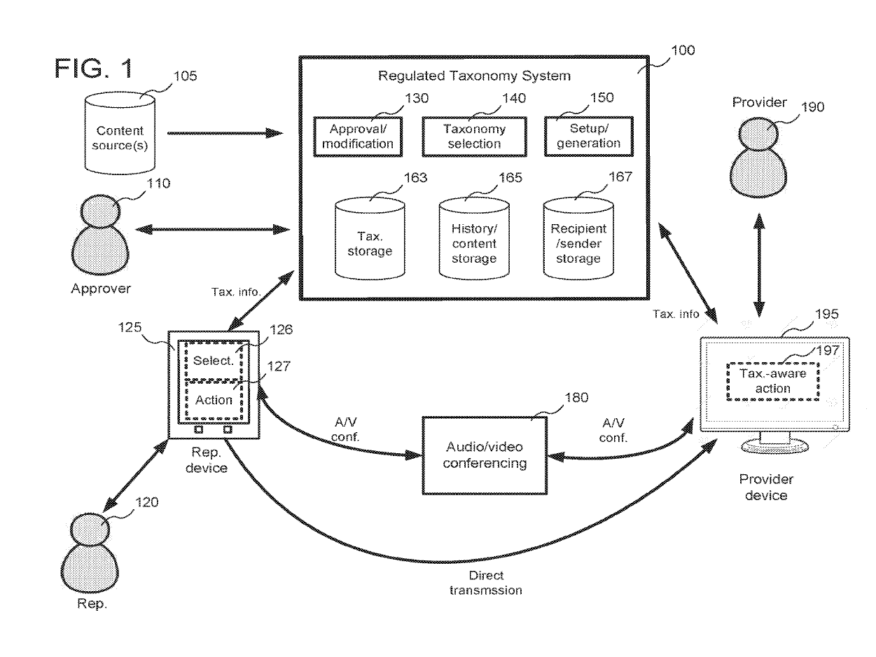

Referring now to FIG. 1, an arrangement for a regulated taxonomy system 100 (“RTS 100”) is illustrated in accordance with various embodiments. In various embodiments, the RTS 100 may be configured to generate and provide regulated taxonomy for association with communication and content, such as that shared between a representative 110 and a provider 190. In various embodiments, the RTS 100 may be configured to communicate with one or more other computing devices, such as a representative device 125 associated with a representative 120. The RTS 100 may also be configured to communicate with a provider device 195 associated with the provider 190. It may be noted that the representative device 125 is illustrated as a tablet, while the provider device 195 is illustrated as a desktop computer; this particular illustration is done to show a diversity of devices. However, it may be recognized that the representative device 125 and/or the provider device 195 may include various devices which may be suitable for communication and/or sharing, consumption, and/or modification of content, including, but not limited to, mobile devices and mobile phones, tablet devices, laptop computers, desktop computers, VOIP phones, video teleconferencing equipment, etc. Additionally, it may be recognized that, while the examples provided herein are made with reference to a single provider 190, in various embodiments, multiple provider 190 may communicate with a single representative 120. Additionally, while single devices are illustrated, in other embodiments, multiple provider devices 195 or representative devices 125 may be utilized. In various embodiments, the representative device 125 may be configured to communicate and/or share content with the provider device. As illustrated, this may include direct communication, such as direct sending of a piece of content between the representative device 120 and the provider device 190, or mediated communication, such as via an audio or video conferencing system 180.

As shown in FIG. 1, in various embodiments, the representative device 125 and/or the provider device 195 may be configured with one or more taxonomy-aware action modules (“TAM”) 127 and/or 197, as illustrated in FIG. 1 by the dashed line element labeled “Action” or “Tax-aware action”. In various embodiments, the one or more TAM 127 and/or 197 may be configured to perform one or more actions with respect to a piece of content or communication being performed between the representative device 125 and the provider device 195. These actions may be performed based on one or more pieces of taxonomy that are associated with a piece of content and/or communication. In various embodiments, the TAM 127 and/or 197 may be configured to perform action relating to modification of content itself such as, but limited to, addition of information to content, and deletion and/or redaction of information from content, format modification, etc. In various embodiments, the TAM 127 and/or 197 may be configured to perform sharing modifications, such as addition or removal of sharing recipients, change to a list of types of formats a piece of content may be shared in, limits to future sharing of the piece of content by recipients, etc. Additionally, the representative device 125 may include a selection module 126 (“SM 126”), which may be configured to receive taxonomy information from the RTS 100 and to provide one or more pieces of taxonomy to the representative 120 (or other user) for selection. Particular activities of the TAM 127 and/or 197 and/or the SM 126 may be described below.

In various embodiments, the RST 100 may itself include one or more modules which may be utilized for generation and provision of regulated taxonomy for association with communication and content. As discussed herein, in these modules may be implemented in various manners, as may be understood, including software, hardware, and various combinations thereof. In various embodiments, the RTS 100 may include a setup/generation module 150 (“SG 150”) which may be configured to setup an initial set of taxonomy for usage according to techniques described herein. In various embodiments, the SG 150 may be configured to receive content from one or more content sources 105. The content sources, in various embodiments, may include automated sources, such as content feeds, web sites, or other automated publishing technologies. In various embodiments, the SG 150 may also be configured to receive content which is provided manually, or which is stored locally, such as in history/content storage 165. In various embodiments, the SG 150 may be configured to generate pieces of regulated taxonomy from received content. For example, the SG 150 may be configured to analyze a piece of received content to determine common topics which may be utilized as taxonomy relating to the piece of received content. For example, if a brochure about a pediatric melanoma drug is received from a content source 105, the SG 150 may be configured to analyze the content of the brochure to identify common topics/descriptors, such as “melanoma”, “pediatrics”, “cancer”, etc. In some embodiments, the SG 150 may be configured to identify headers in the received content to help generate taxonomy. In other embodiments, the SG 150 may analyze received content to determine one or more persons associated with the content, such as authors cited in a piece of content or persons associated it referenced persons. In various embodiments, the SG 150 may rely on associations between providers or other recipients of content, such as may be kept in the recipient/sender storage 167 (“RS 167”). Particular techniques for setting up and generating taxonomy may be described below.

In various embodiments, taxonomy generated by the SG 150 may take various forms. In various embodiments, a piece of taxonomy may include a handle, which may include an easy-to-understand word, phrase, and/or series of characters which may be applied to a communication or piece of content. This handle may be indicated using a character (or other) indicator, such as, for example, a hashtag (“#”). In other embodiments, other indicators may be utilized. In various embodiments, a piece of taxonomy may be directly related to a topic of a piece of content or communication. For example, for a piece of content relating to a drug, called “PedsMelX” which may be used for pediatric melanoma, a piece of taxonomy may have a handle called #pedsmelx, #pediatrics, #melanoma, etc. In various embodiments, regulated taxonomy may be related to a sub-topic of the content, such as #introduction, #references, #dosage, etc. In various embodiments, the regulated taxonomy may be related to particular recipients (either current or potential) of a communication or piece of content. For example, the for a communication relating to the “PedsMelX” drug, a piece of taxonomy may be related to a specified provider that may be interested in learning about the drug, or who works in pediatric melanoma, such as #drpeds, etc. In various embodiments, in addition to the handle a piece of regulated taxonomy may include descriptions of actions which may be performed with relation to a piece of content or communication to which the piece of regulated taxonomy has been applied. For example, the piece of taxonomy may include indications of specific recipients, or groups of recipients which may be permitted to receive the piece of content. In another embodiment, the piece of content may include information which may be added to the piece of content, or indications of information which may be removed or redacted from the piece of content. In various embodiments, the piece of taxonomy may include indications of actions which are compulsory, such as regulation-based addition or removal of content, and which are elective, such as inclusion of particular recipients. In various embodiments, pieces of taxonomy may include other descriptions of actions.

In various embodiments, the RTS 100 may also include an approval/modification module 130 (“AM 130”), which may be configured to allow for approval and/or modification of one or more pieces of regulated taxonomy. For example, the AM 130 may present pieces of taxonomy to an approver 110, including a handle for the piece of taxonomy and descriptions of actions that are associated with the piece of taxonomy. In various embodiments, the AM 130 may present pieces of taxonomy as they are created, such as by the SG 150, from various pieces of content. In various embodiments, the AM 130 may allow for an approver 110 to do one or more of approve a piece of taxonomy, reject the piece of taxonomy, or modify the piece of taxonomy. For example, the AM 130 may provide the approver 110 the ability to modify a handle of a piece of taxonomy and/or one or more descriptions of actions which may be performed in association with the piece of taxonomy. In various embodiments, the AM 130 may also be configured to perform modification to regulated taxonomy based on actions or communications performed in association with pieces of taxonomy. Thus, in various embodiments, the AM 130 may receive indications of actions which have been performed with respect to content associated with one or more pieces of content. The AM 130 may then modify actions or other information of regulated taxonomy in response to these actions. The RTS 100 may thus incorporate machine learning to modify and update regulated taxonomy as it is used. In other embodiments, the RTS 100 may include a taxonomy selection module 140 (“TS 140”) which may be configured to select one or more pieces of regulated taxonomy for presentation, such as to a representative 120 on the representative device 125, for association with a communication or piece of content. Various embodiments of actions performed by the AM 130 and TS 140 may be described below.

Also as illustrated in FIG. 1, the RTS 100 may include various storage modules, which may be configured to receive and maintain information to facilitate the activities performed thereby. These storage modules may include a taxonomy storage 163 (“TSG 163”), which may be configured to store, for example, one or more pieces of regulated taxonomy. In various embodiments, the TSG 163 may store the regulated taxonomy in various manners, such as, but not limited, to, a relational database, graph database, key-value store, document-oriented database, or other storage structure. The TSG 163 may, in various embodiments, store approved pieces of taxonomy and/or pieces of taxonomy prior to approval. In various embodiments, the RTS 100 may also include a history/content storage 165 (“HCG 165”), which may store content for which pieces of taxonomy may be applied, as well as history of actions which have been performed using the pieces of content; in various embodiments, this history may be utilized to modify taxonomy, as described herein. The RTS 100 may also include a recipient/sender storage 167 (“RSG 167”), which may store information relating to one or more persons or groups which may receive content. The RTS 100 may, in various embodiments, include other modules and/or facilities not illustrated in FIG. 1, as may be described herein.

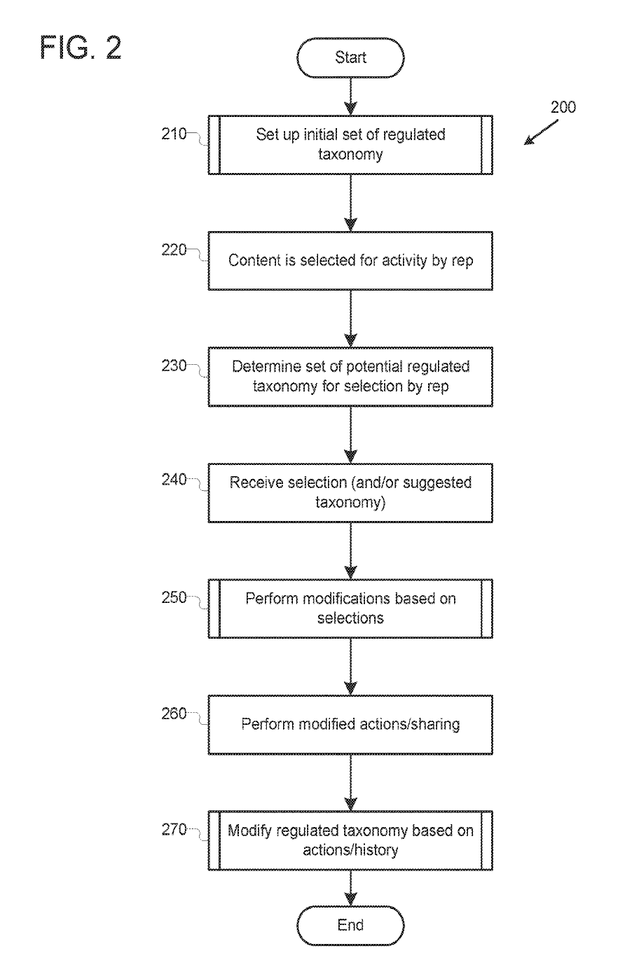

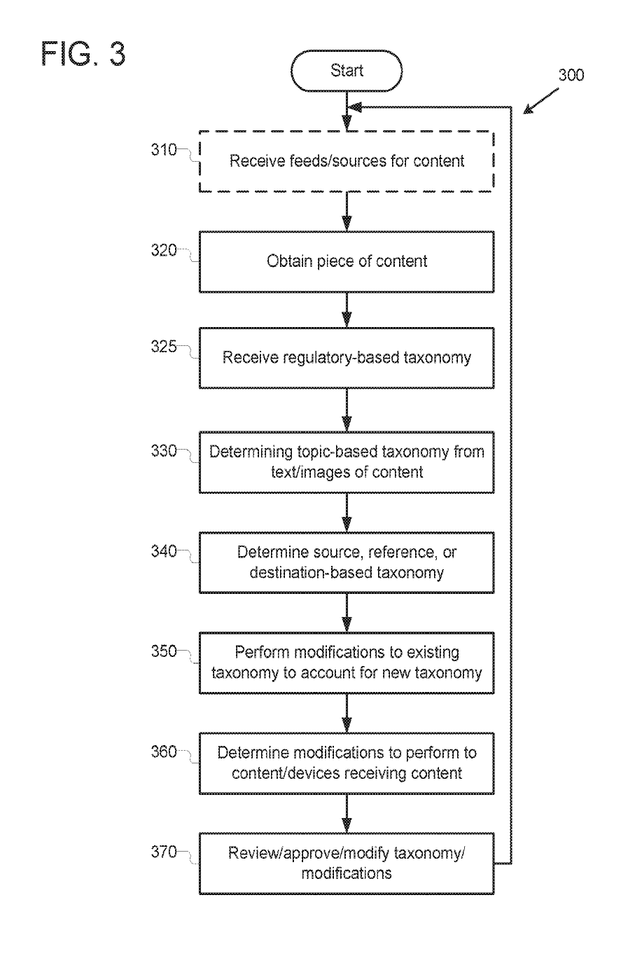

Referring now to FIG. 2, an example process 200 for facilitating communication using regulated taxonomy is illustrated in accordance with various embodiments. While FIG. 2 illustrates particular example operations, in various embodiments, the process may include additional operations, omit illustrated operations, and/or combine illustrated operations. The process may begin at operation 210, where the SG 150 may set up an initial set of regulated taxonomy, such as by analyzing one or more pieces of content. Particular implementations of operation 210 are described below with reference to process 300 of FIG. 3. It may be noted as well that, while the process of FIG. 2 illustrates operation 210 as occurring in an initial point in time, in various embodiments, operation 210 may be performed before, during, or after communications and/or may be repeated to generate additional regulated taxonomy.

Next, at operation 220, in various embodiments, the representative 120 may select a piece of content for an activity. For example, the representative 120 may select a piece of content that they wish to share with a provider 190, such as at the representative device 125. In another embodiment, the representative 120 may elect to perform a communication at operation 220, and may elect to record this conversation, thereby generating a new piece of content. In another embodiment, the representative 120 may initiate a communication with a provider 190 which is not recorded, however, a history of the communication may be saved as a piece of content for later usage. Next, at operation 230, the TS 140 may determine a set of potential regulated taxonomy for the selection by the representative 120. In various embodiments, the TS 140 may consult the TSG 163 to determine if one or more pieces of taxonomy have previously been associated with a piece of content being selected or a recipient of a communication. In other embodiments, the TSG 163 may include one or more relations between pieces of taxonomy, such that, when one piece of taxonomy is selected by the TS 140, other pieces of taxonomy may be determined for presentation to the representative 120. In other embodiments, the TS 140 may select pieces of taxonomy based on an identity of the representative 120 and/or the provider 190. These selected pieces of taxonomy may be provided to the representative device 125 for presentation to the representative 120, such as on the SM 126.

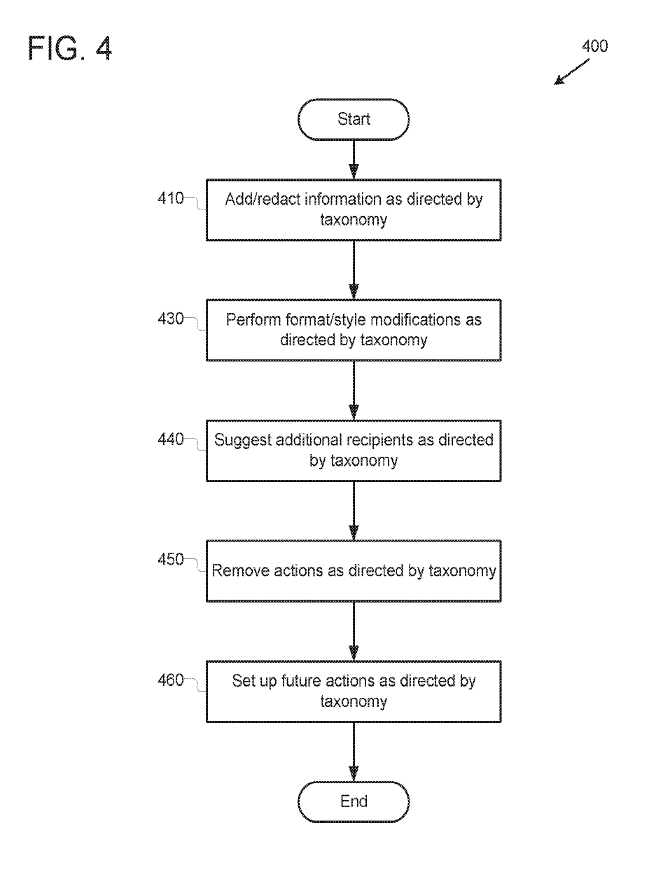

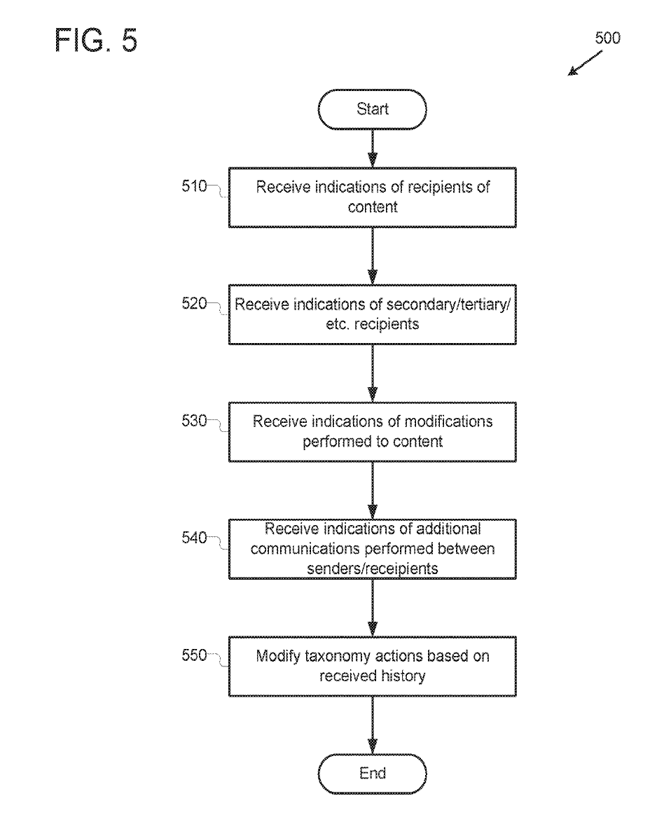

Next, at operation 240, the RTS 100 may receive a selection of one or more of the pieces of regulated taxonomy that were provided to the representative device 120. The selection may be received from the SM 126, such as from a list of pieces of taxonomy. Next, at operation 250, the TAM 127 may perform one modifications based on the selected pieces of taxonomy. For example, the piece of content may be modified to add or remove particular information, and/or a set of recipients for the piece of content may be modified. Particular implementations of operation 250 are described below with reference to process 400 of FIG. 4. At operation 260, one more actions may be performed. For example, the piece of content may be shared or viewed, or a communication may be performed. In another example, content, recipients, or applications to use with content may be suggested or predicted based on taxonomy. In yet other examples, Next, at operation 270, the regulated taxonomy may be modified based on actions performed using the piece of content and/or its history, such as by the AM 130. Particular implementations of operation 270 are described below with reference to process 500 of FIG. 5. The process may then end.

Referring now to FIG. 3, an example process 300 for setting up an initial set of regulated taxonomy is illustrated in accordance with various embodiments. While FIG. 3 illustrates particular example operations, in various embodiments, the process may include additional operations, omit illustrated operations, and/or combine illustrated operations. In various embodiments, process 300 may include one or more implementations of operation 210 of FIG. 2. In various embodiments, the process of FIG. 3 may be performed by the SG 150 of the RTS 100. The process may begin at operation 310, where the SG 150 may receive one or more sources for receipt of content. In various embodiments, such sources may include external sources, such as content feeds, web sites, file sharing services, etc. In other embodiments, the content sources may include local resources such as networked or local storage devices, etc. Next, at operation 320, the RTS 100 may obtain a piece of content from one of the sources. In various embodiments, the SG 150 may poll a feed for content or may receive a notification and may fetch the piece of content from a remote location; in other embodiments, the SG 150 may be directly sent the content. Next, at operation 325, the SG 150 may receive one or more pieces of regulatory-based taxonomy. For example, the SG 150 may receive pieces of taxonomy that may indicate that a piece of content is a regulated drug, or is being sent in a regulated communication. Such taxonomy may have associated with it particular information, such as information to be included in a piece of content, or information to be removed or redacted from content.

Next, at operation 330, the SG 150 may determine topic-based taxonomy from analysis of text and/or images in the piece of content. Thus, in various embodiments, the SG 150 may review text in the piece of content to determine one or more topics which are commonly referenced in the piece of content. In other embodiments, the SG 150 may analyze the piece of content to determine topics which are included in titles and/or headers in the piece of content. In other embodiments, the SG 150 may analyze the piece of content to determine if any topics may be suggested by the images, such as by performing an image lookup to determine text associated with the images.

Next, at operation 340, the SG 150 may determine source, reference, and/or recipient-based taxonomy for the piece of content. Thus, the SG 150 may generate taxonomy based on a content source 105 for the piece of content. In another embodiment, the SG 150 may generate taxonomy based on one or more references, such as to other pieces of content, or persons, which are made in the piece of content. In yet other embodiments, the SG 150 may determine taxonomy based on recipients of the piece of content. In various embodiments, the recipients may be predicted recipients which are likely to receive content, such as based on the content source 105 or the topic of the content.

Next, at operation 350, the SG 150 may perform modifications to an existing piece of regulated taxonomy to account for newly determined taxonomy. For example, if a series of persons are referenced frequently in a piece of content that is associated with a particular topic, they may be added to a list of recipients associated with that topic. In another example, if a drug is associated with a new malady, a piece of taxonomy for that malady may be modified to account for information in the piece of content. Next, at operation 360, the SG 150 may determine modification actions which may be performed to content or devices which receive the content. For example, the SG 150 may determine that, because the piece of taxonomy is associated with regulation, that a modification action should be included in the piece of taxonomy to add particular information to a piece of content with which the piece of taxonomy is associated. Next, at operation 370, the SG 150 may provide the generated taxonomy to one or more approvers 110 to review and approve/reject/modify. After operation 370, the process may repeat for another piece of received content. If no additional content is received, the process may end.

Referring now to FIG. 4, an example process 400 for performing modifications of actions or content based on selected taxonomy in accordance with various embodiments. While FIG. 4 illustrates particular example operations, in various embodiments, process 400 may include additional operations, omit illustrated operations, and/or combine illustrated operations. In various embodiments, process 300 may include one or more implementations of operation 250 of FIG. 2. In various embodiments, the process of FIG. 4 may be performed by the TAM 127 and/or 197 of the respective representative device 125 and/or the provider device 195. The process may begin at operation 410, where the TAM 127 and/or 197 may add, redact, and/or remove information as directed according to the actions described in a piece of taxonomy associated with the piece of content. In various embodiments, the piece of taxonomy may include information which is to be added to a piece of content, or may include information (or descriptions of information) which may be removed or redacted from a piece of content. Next, at operation 430, the TAM 127 and/or 197 may perform one or more modifications of format and/or style of a piece of content as directed by one or more pieces of taxonomy. Next, at operation 440, the TAM 127 and/or 197 may suggest one or more additional recipients of a piece of content or communication based on one or more pieces of taxonomy. For example, if a piece of taxonomy has a particular set of providers associated with it, and the piece of content is being sent to a subset of that set of providers, the TAM 127 and/or 197 may suggest additional providers that are missing from the current subset.

Next, at operation 450, the TAM 127 and/or 197 may remove one or more actions from selection as directed by the piece of taxonomy. For example, the piece of taxonomy may direct that a piece of content may not be able to be shared at all, or may only be shared in particular formats (such as uneditable formats). In other embodiments, the TAM 127 and/or 197 may remove one or more possible recipients for sharing. In yet other embodiments, the TAM 127 and/or 197 may remove the ability of the provider to edit or otherwise modify the piece of content. Next, at operation 460, the TAM 127 and/or 197 may trigger future actions which may be directed by one or more pieces of taxonomy. For example, the TAM 127 and/or 197 may set up a trigger to initiate a future communication relating to the piece of content. In another example, the TAM 127 and/or 197 may set up a trigger to follow up on a current communication or shared piece of content. After operation 460, the process may end.

Referring now to FIG. 5, an example process 500 for modifying taxonomy is illustrated in accordance with various embodiments. In various embodiments, the AM 130 may perform operations of process 500 in order to provide for machine learning whereby the RTS 100 may update regulated taxonomy based on actions performed using regulated taxonomy. While FIG. 5 illustrates particular example operations, in various embodiments, the process may include additional operations, omit illustrated operations, and/or combine illustrated operations. In various embodiments, process 500 may include one or more implementations of operation 270 of FIG. 2. In various embodiments, process 500 of FIG. 5 may be performed by the AM 130, and may include operations by the TSG 163, HCG 165, and/or RSG 167. The process may begin at operation 510, where there AM 130 may receive indications of one or more recipients of a piece of content who were sent the piece of content from the representative 120. Next, at operation 520, the AM 130 may receive indications of secondary, tertiary, or other recipients, such as providers or other recipients who may have had the piece of content shared with them by the provider 190. Next, at operation 530, the AM 130 may receive indications of modifications which were performed to the piece of content, such as by the TAM 127 and/or 197. At operation 540, the AM 130 may receive indications of additional communications which were performed between senders and recipients. Next, at operation 550, the AM 130 may modify regulated taxonomy actions based on the received history. For example, if a piece of content with a first piece of taxonomy leads to request for a second piece of content, a new piece of taxonomy may be created which combines concepts of the first piece of taxonomy and the second piece of content. For example, if a pediatrician provider 190 downloads a efficacy white paper based on material sent by a representative 120 and associated with a #dosing taxonomy, a new modified taxonomy may be based on efficacy, such as #dosing-efficacy or #efficacy-pediatrician. The process may then end.

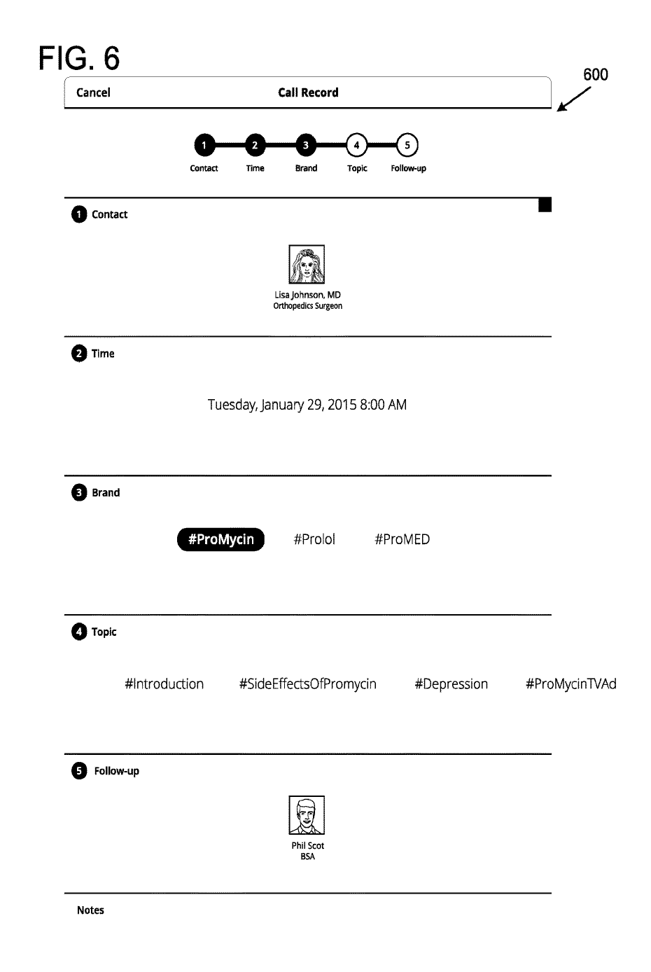

Referring now to FIG. 6, an example interface provided by provided by one or more modules of a representative device 125 are illustrated according to some of the techniques described herein. While particular example interfaces are illustrated, in various embodiments, other interfaces may be utilized. Additionally, while the example of FIG. 6 may be generated by the SM 126 or the TAM 127 of the representative device 125, in other embodiments, the interfaces may be generated, in whole or in part, by modules at the RTS 100 and merely presented by the representative device 125 (e.g., the representative device 125 may include a browser displaying one or more web pages provided by the RTS 100).

In FIG. 6, a call record screen 600 is illustrated. The call record screen 600 shows a provider 190 (“Lisa Johnson, MD”) and a time for a call between the representative 120 and the provider 190. The call record screen 600 also shows selections of pieces of taxonomy relating to various brands of drugs which may have been talked about on the call, including #ProMycin, #Prolol, and #ProMED. The call record screen also shows selections of pieces of taxonomy relating to various topics, including #SideEffectsOfPromycin, #Depression, and #ProMycinTV Ad. The call record screen 600 also shows a follow-up person, who may be assigned according to a selected piece of taxonomy.

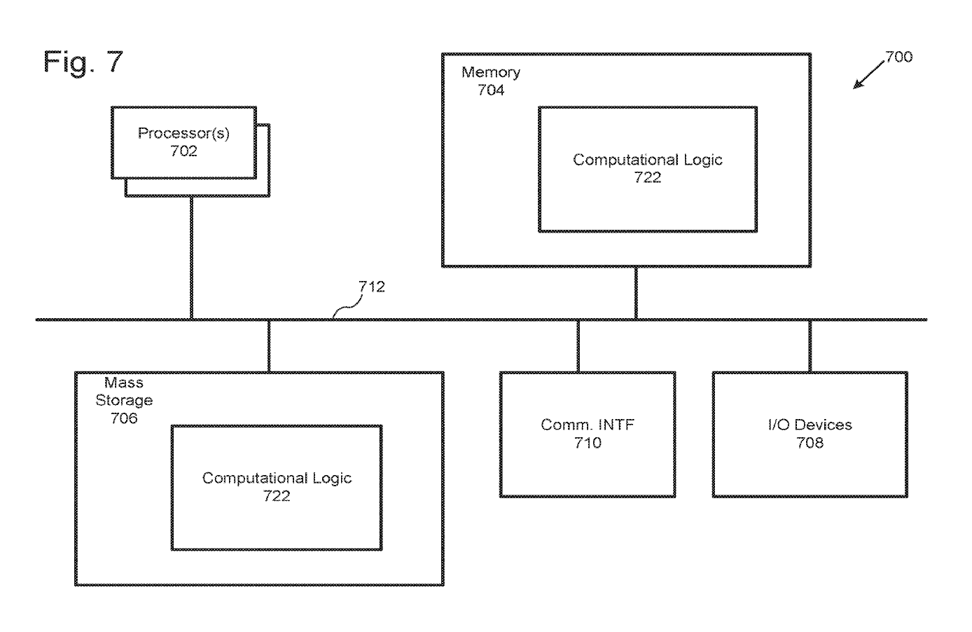

Referring now to FIG. 7, an example computer suitable for practicing various aspects of the present disclosure, including processes described herein, is illustrated in accordance with various embodiments. As shown, computer 700 may include one or more processors or processor cores 702, and system memory 704. For the purpose of this application, including the claims, the terms “processor” and “processor cores” may be considered synonymous, unless the context clearly requires otherwise. Additionally, computer 700 may include mass storage devices 706 (such as diskette, hard drive, flash drive, solid state drive, compact disc read only memory (CD-ROM) and so forth), input/output devices 708 (such as display, keyboard, cursor control, remote control, gaming controller, image capture device, and so forth) and communication interfaces 710 (such as network interface cards, modems, infrared receivers, radio receivers (e.g., Bluetooth), and so forth). The elements may be coupled to each other via system bus 712, which may represent one or more buses. In the case of multiple buses, they may be bridged by one or more bus bridges (not shown). Elements such as mass storage may be physically separate or remote.

Each of these elements may perform its conventional functions known in the art. In particular, system memory 704 and mass storage devices 706 may be employed to store a working copy and a permanent copy of the programming instructions implementing the operations associated with facilitation of communication with selected specialists as shown in processes described herein. The various elements may be implemented by assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of the processes described herein may be employed to distribute the programming instructions and program various computing devices.

The number, capability and/or capacity of these elements 710-712 may vary, depending on how computer 700 is used. Their constitutions are otherwise known, and accordingly will not be further described.

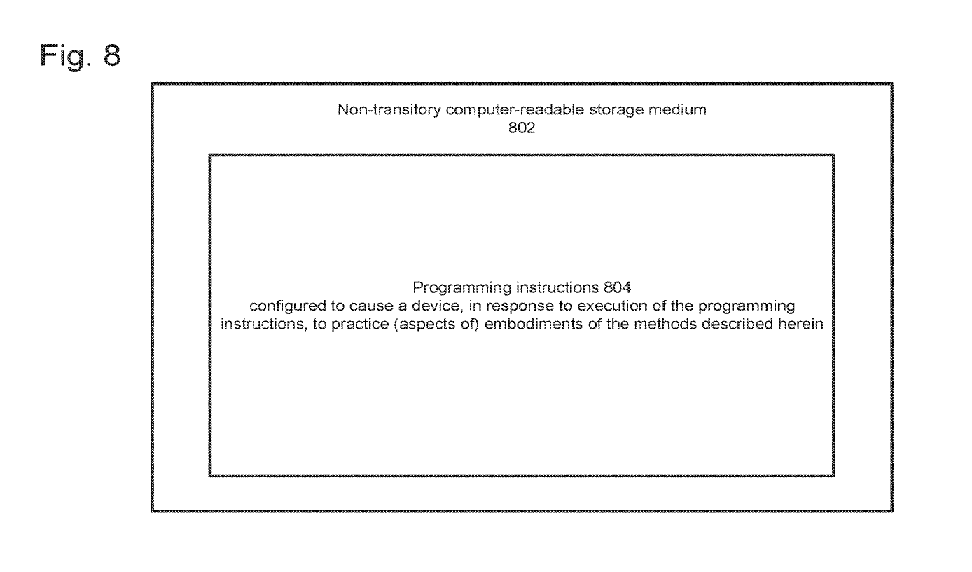

FIG. 8 illustrates an example least one computer-readable storage medium 802 having instructions configured to practice all or selected ones of the operations associated with techniques described herein. As illustrated, least one computer-readable storage medium 802 may include a number of programming instructions 804. Programming instructions 804 may be configured to enable a device, e.g., computer 700, in response to execution of the programming instructions, to perform, e.g., various operations of processes described herein, but not limited to, to the various operations performed to modify and share content. In alternate embodiments, programming instructions 804 may be disposed on multiple computer-readable storage media 802 instead.

Referring back to FIG. 7, for one embodiment, at least one of processors 702 may be packaged together with computational logic 722 configured to practice aspects of processes described herein. For one embodiment, at least one of processors 702 may be packaged together with computational logic 722 configured to practice aspects of processes of described herein to form a System in Package (SiP). For one embodiment, at least one of processors 702 may be integrated on the same die with computational logic 722 configured to practice aspects of processes of described herein. For one embodiment, at least one of processors 702 may be packaged together with computational logic 722 configured to practice aspects of processes of described herein to form a System on Chip (SoC). For at least one embodiment, the SoC may be utilized in, e.g., but not limited to, a computing tablet.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1. A method for facilitating usage of content, the method comprising:
receiving, by a computing system, a piece of content from a first party;
providing, by the computing system, the piece of content to a computing device other than the computing system;
suggesting, by the computing system, one or more suggested pieces of taxonomy to be associated with the piece of content, the one or more pieces of taxonomy including respective one or more actions to be taken with respect to the piece of content;
receiving, by the computing system, from the computing device, a selection of a selected piece of taxonomy;
performing, by the computing system or the computing device, an action associated with the selected piece of taxonomy using the piece of content, wherein the action comprises removing a functionality of the computing device with respect to the piece of content.

2. (canceled)

3. The method of claim 1, wherein the removing the functionality comprises removing an ability to share the piece of content with one or more recipients.

4. The method of claim 3, wherein the removing the functionality comprises removing an ability to modify the piece of content.

5. The method of claim 1, wherein performing the action comprises adding new information to the piece of content.

6. The method of claim 5, wherein adding new information comprises adding regulatory text to the piece of content.

7. The method of claim 1, wherein performing the action comprises redacting information in the piece of content.

8. The method of claim 7, wherein redacting information comprises:
determining one or more recipients associated with the selected piece of taxonomy;
determining information that is prevented from being viewed by the determined one or more recipients;
redacting the determined information.

9. The method of claim 1, further comprising generating at least one of the one or more suggested pieces of taxonomy.

10. The method of claim 9, wherein generating at least one of the one or more suggested pieces of taxonomy comprises reviewing information in the piece of content to determine one or more common topics in the piece of content.

11. The method of claim 10, wherein generating at least one of the one or more suggested pieces of taxonomy further comprises combining two or more determined common topics.

12. The method of claim 9, wherein generating at least one of the one or more suggested pieces of taxonomy comprises generating taxonomy relating to a recipient of the piece of content.

13. One or more non-transitory computer-readable media containing instructions written thereon that, in response to execution on a computing system, cause the computing system to facilitate usage of content by causing the computing system to:
receive a piece of content from a first party;
provide the piece of content to a computing device other than the computing system;
suggest one or more suggested pieces of taxonomy to be associated with the piece of content, the one or more pieces of taxonomy including respective one or more actions to be taken with respect to the piece of content;
receive, from the computing device, a selection of a selected piece of taxonomy;
perform an action associated with the selected piece of taxonomy using the piece of content, wherein the action comprises remove a functionality of the computing device with respect to the piece of content.

14. (canceled)

15. The computer-readable media of claim 13, wherein remove the functionality comprises remove an ability to share the piece of content with one or more recipients.

16. The computer-readable media of claim 15, wherein remove the functionality comprises remove an ability to modify the piece of content.

17. The computer-readable media of claim 13, wherein perform the action comprises add new information to the piece of content.

18. The computer-readable media of claim 17, wherein add new information comprises adding regulatory text to the piece of content.

19. The computer-readable media of claim 13, wherein perform the action comprises redact information in the piece of content.

20. The computer-readable media of claim 19, wherein redact information comprises:
determine one or more recipients associated with the selected piece of taxonomy;
determine information that is prevented from being viewed by the determined one or more recipients;
redact the determined information.

21. The computer-readable media of claim 13, wherein the instructions further cause the computing system to generate at least one of the one or more suggested pieces of taxonomy.

22. The computer-readable media of claim 21, wherein generate at least one of the one or more suggested pieces of taxonomy comprises review information in the piece of content to determine one or more common topics in the piece of content.

23. The computer-readable media of claim 22, wherein generate at least one of the one or more suggested pieces of taxonomy further comprises combine two or more determined common topics.

24. The computer-readable media of claim 21, wherein generate at least one of the one or more suggested pieces of taxonomy comprises generate taxonomy relating to a recipient of the piece of content.

25. An apparatus to facilitate usage of content, the apparatus comprising:
one or more computing processors; and
one or more modules to operate on the one or more computing processors to:
receive a piece of content from a first party;
provide the piece of content to a computing device other than the apparatus;
suggest one or more suggested pieces of taxonomy to be associated with the piece of content, the one or more pieces of taxonomy including respective one or more actions to be taken with respect to the piece of content;
receive, from the computing device, a selection of a selected piece of taxonomy;
facilitate performance of an action associated with the selected piece of taxonomy using the piece of content, wherein performance of the action comprises removal of a functionality of the computed device with respect to the piece of content.

26. (canceled)

27. The apparatus of claim 25, wherein removal of the functionality comprises removal of an ability to share the piece of content with one or more recipients.

28. The apparatus of claim 27, wherein removal of the functionality comprises removal of an ability to modify the piece of content.

29. The apparatus of claim 25, wherein performance of the action comprises addition of new information to the piece of content.

30. The apparatus of claim 29, wherein addition of new information comprises addition of regulatory text to the piece of content.

31. The apparatus of claim 25, wherein performance of the action comprises redaction of information in the piece of content.

32. The apparatus of claim 31, wherein redact information comprises:
determine one or more recipients associated with the selected piece of taxonomy;
determine information that is prevented from being viewed by the determined one or more recipients;
redact the determined information.

33. The apparatus of claim 25, wherein the modules are further to operate to generate at least one of the one or more suggested pieces of taxonomy.

34. The apparatus of claim 33, wherein generate at least one of the one or more suggested pieces of taxonomy comprises review information in the piece of content to determine one or more common topics in the piece of content.

35. The apparatus of claim 34, wherein generate at least one of the one or more suggested pieces of taxonomy further comprises combine two or more determined common topics.

36. The apparatus of claim 35, wherein generate at least one of the one or more suggested pieces of taxonomy comprises generate taxonomy relating to a recipient of the piece of content.

37.-39. (canceled)
